(19) United States
(12) Patent Application Publication
(10) Pub. No.: US 2026/0336441 A1
(43) Pub. Date: Oct. 29, 2026

(54) CHARGING CABLE

(71) Applicant: LG ELECTRONICS INC., Seoul (KR)

(72) Inventors: Naehyun PARK, Seoul (KR); Jiho LEE, Seoul (KR)

(73) Assignee: LG ELECTRONICS INC., Seoul (KR)

(21) Appl. No.: 19/107,298

(22) PCT Filed: Dec. 6, 2022
(86) PCT No.: PCT/KR2022/019678

§ 371 Date: Feb. 27, 2025

(51) Int. Cl. B60L 53/18; B60L 53/302; H01B 7/02; H01B 7/42; H01B 9/00

(52) U.S. Cl. CPC B60L 53/18; B60L 53/302; H01B 7/02; H01B 7/423; H01B 9/003

(57) ABSTRACT

One example of a charging cable according to the present embodiment comprises; an outer tube; a communication line arranged inside the outer tube; and at least one charging line which is arranged inside the outer tube, and which has an inner flow path through which a coolant passes, wherein an outer flow path through which the coolant passes is formed between the outer tube, the communication line, and the at least one charging line, and the cross-sectional area of the inner flow path is smaller than the cross-sectional area of the outer flow path.

### TECHNICAL FIELD

The present disclosure relates to a charging cable for charging electric vehicles or the like.

### BACKGROUND ART

The higher the current in any conductor, the more heat is generated. As a result, the conductors between the charging device and the vehicle have become larger in size to accommodate higher inrush currents.

An example of a charging system capable of charging an electric vehicle is the charging system for an electric vehicle disclosed in Republic of Korea Patent Publication No. 10-1952159 B1 (published on Feb. 26, 2019), and the charging system for an electric vehicle comprises a power supply; a cable having a first end portion and a second end portion, the first end portion being attached to the power supply, the cable having a conductor and a cooling pipe each extending from the first end portion to the second end portion; and a connector attached to the second end portion of the cable and having a form factor corresponding to a charging port of the electric vehicle, and the cooling pipe may be in contact with a conductor.

### DISCLOSURE

### Technical Problem

An abject of the present embodiment is to provide a charging cable in which the cooling fluid can cool the charging line as much as possible and the cooling fluid can cool the charging line more quickly.

An abject of the present embodiment is to provide a charging cable in which the heat exchange between the cooling fluid and the charging conductor is large and the pressure loss of the cooling fluid is small.

### Technical Solution

One example of a charging cable according to the present embodiment may comprise an outer tube; a communication line arranged inside the outer tube; and at least one charging line disposed inside the outer tube and having an inner flow path formed through which cooling fluid passes, wherein an outer flow path through which cooling fluid passes is formed between the outer tube, the communication line, and the at least one charging line, wherein a cross-sectional area of the inner flow path may be smaller than a cross-sectional area of the outer flow path.

The charging cable may further comprise a cooling fluid supply unit configured to supply cooling fluid to the inner flow path, and a cooling fluid recovery unit through which the cooling fluid passing through the outer flow path is guided.

At least one cooling fluid recovery hole through which the cooling fluid of the inner flow path flows to the outer flow path may be formed on the insulating body.

The cross-sectional area of the inner flow path may be 0.2 to 0.6 times the cross-sectional area of the outer flow path.

The charging line may comprise at least one charging conductor; and an insulating body surrounding an outer circumference of the at least one charging conductor.

The inner flow path may be formed on an inner circumference of the insulating body and may be long in a longitudinal direction of the insulating body.

The insulating body may comprise a plurality of insulating portions surrounding an outer circumference of the charging conductor, and a bridge portion connecting adjacent insulating portions among the plurality of insulating portions.

At least one cooling fluid recovery hole through which the cooling fluid of the inner flow path flows to the outer flow path may be formed on the bridge portion.

The charging cable may further comprise a supporter disposed inside the outer tube and formed with a charging line penetration hole through which the charging line passes and a communication line penetration hole through which the communication line passes. A plurality of through holes is formed in the supporter.

The supporter may be disposed in plurality inside the outer tube, the plurality of supporters may be spaced apart in a longitudinal direction of the

Another example of a charging cable according to the present embodiment may comprise an outer tube; a communication line disposed inside the outer tube; at least one charging line disposed inside the outer tube and having an inner flow path formed through which a cooling fluid passes; a cooling fluid supply body supplying cooling fluid to the inner flow path; and a cooling fluid recovery body guiding the cooling fluid passing through the outer flow path, an outer flow path through which the cooling fluid passes is formed between the outer tube, the communication line, and at least one charging line, and a cross-sectional area of the inner flow path may be 0.2 to 0.6 times a cross-sectional area of the outer flow path.

The other example of a charging cable according to the present embodiment may comprise an outer tube; a communication line and at least one charging line disposed inside the outer tube; and a supporter disposed inside the outer tube and having a charging line through-hole through which the charging line passes and a communication line through-hole through which the communication line passes are formed, a plurality of through-holes for dispersing the cooling fluid may be formed on the supporter

### Advantageous Effect

According to this embodiment, the cross-sectional area of the inner flow path formed inside the insulation body of the charging line is smaller than the area of the outer flow path formed outside the insulation body, so that the heat exchange amount between the cooling fluid and the charging conductor is high and the pressure loss of the cooling fluid is small, so that the charging conductor can be cooled more efficiently.

In addition, since the cross-sectional area of the inner flow path is 0.2 to 0.6 times the cross-sectional area of the outer flow path, the heat exchange amount of the cooling fluid can be maximized and the pressure loss on the cooling fluid can be minimized.

In addition, since the cooling fluid passes through the inner flow path, the cooling fluid recovery hole, and the outer flow path sequentially, the length of the cooling flow path can be maximized.

In addition, since a separate cooling fluid tube is not arranged inside the outer tube, the generation of condensate can be minimized, and the low-temperature cooling fluid can quickly cool the charging conductor.

### DESCRIPTION OF DRAWINGS

FIG. 1 is a side view of an example of a charging cable according to the present embodiment.

FIG. 2 is a partially cut away perspective view of an example of a charging cable according to the present embodiment.

FIG. 3 is a cross-sectional view illustrating a portion of an example of a charging cable according to the present embodiment.

FIG. 4 is a cross-sectional view taken along line A-A′ of FIG. 3.

FIG. 5 is a partially cut away perspective view illustrating an example of a charging cable according to the present embodiment.

FIG. 6 is a partially cut-away perspective view of a comparative example compared to an example of a charging cable according to the present embodiment.

FIG. 7 is a diagram showing the dryness and density of the cooling fluid according to the present embodiment.

FIG. 8 is a graph showing the heat exchange amount of an example of a charging cable according to the present embodiment and the heat exchange amount of a comparative example.

FIG. 9 is a graph showing the pressure loss on the cooling fluid of an example of a charging cable according to the present embodiment and the pressure loss on the cooling fluid of a comparative example.

FIG. 10 is a perspective view of a supporter according to the present embodiment.

FIG. 11 is a cross-sectional view showing an example of a supporter according to the present embodiment installed inside an outer tube.

FIG. 12 is a perspective view showing an example of a supporter according to the present embodiment installed inside an outer tube.

### BEST MODE

Hereinafter, specific embodiments of the present invention will be described in detail with reference to the drawings.

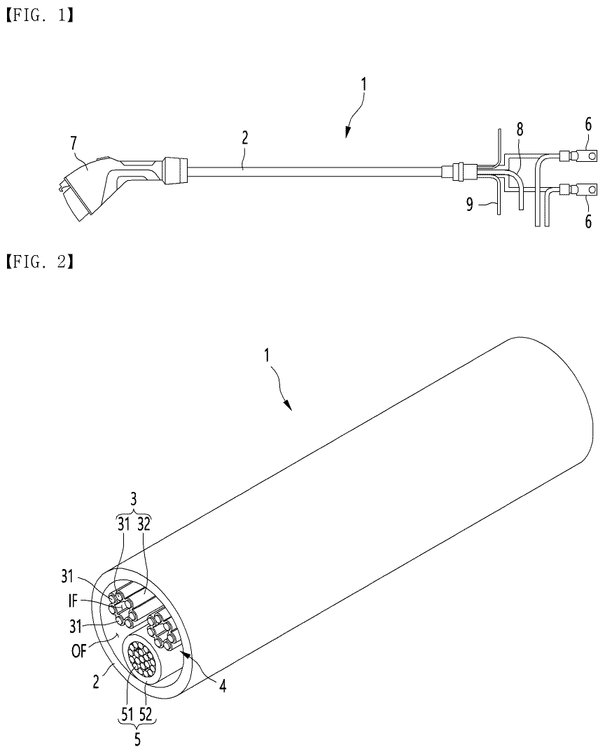

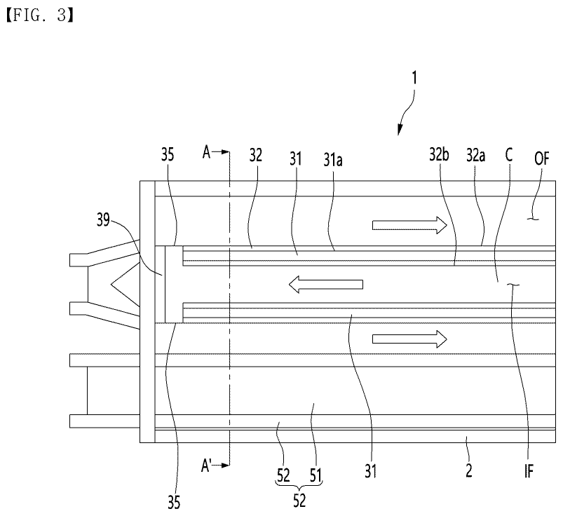

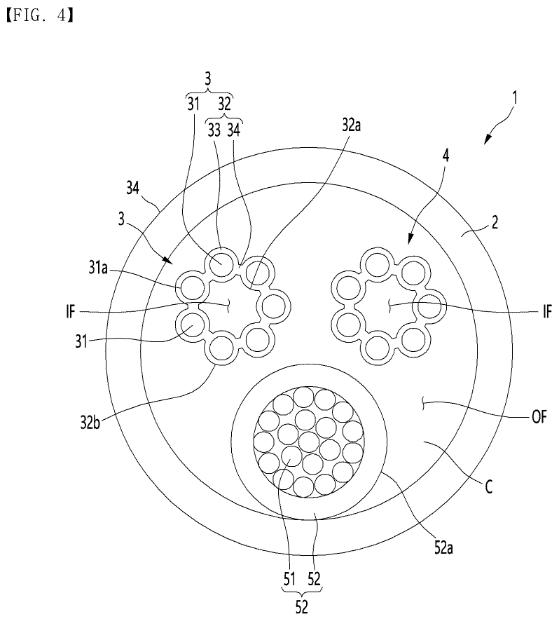

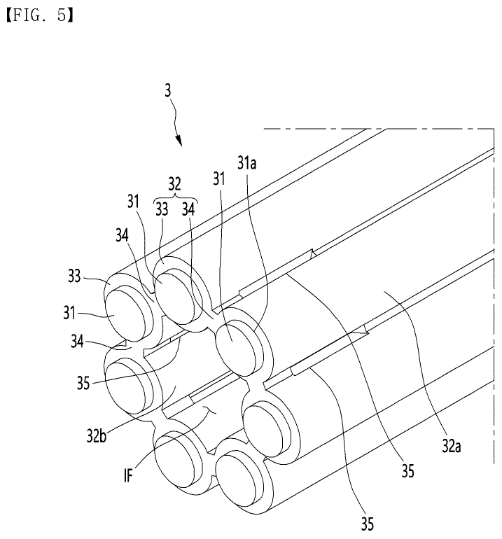

FIG. 1 is a side view of an example of a charging cable according to the present embodiment, FIG. 2 is a partially cut away perspective view of an example of a charging cable according to the present embodiment, FIG. 3 is a cross-sectional view illustrating a portion of an example of a charging cable according to the present embodiment, FIG. 4 is a cross-sectional view taken along line A-A′ of FIG. 3, and FIG. 5 is a partially cut away perspective view illustrating an example of a charging cable according to the present embodiment.

The charging cable 1 may comprise an outer tube 2 and a charging line. The charging cable 1 may further comprise a communication line. The charging cable 1 may be cooled by a cooling fluid C that may change phase (liquefy or vaporize) according to a temperature change.

The charging cable 1 may be connected to a cooler, and the cooling fluid C flowing from the cooler may flow into the interior of the charging cable 1 to cool the charging line and the communication line.

The outer tube 2 may form the outer appearance of the charging cable 1. A space may be formed inside the outer tube 2, and a charging line and a communication line may be accommodated in the space.

The outer tube 2 may be an outer jacket, and the outer jacket may accommodate a charging line and a communication line, and the cooling fluid C may pass through the outer jacket.

A plurality of charging lines may be provided inside the outer tube 2. Hereinafter, a pair of charging lines 34 is disposed inside the outer tube 1. The present embodiment is not limited to accommodating a pair of charging lines 34 inside the outer tube 2, and it is also possible to dispose three or more charging lines, and the number of charging lines is not limited. A pair of charging lines 34 may be formed with the same structure, and for the convenience of explanation below, they are collectively referred to as charging lines 3.

The charging line 3 may comprise at least one charging conductor 31 and an insulating body 32.

The charging conductor 31 may be provided in plurality on one charging line 3. The plurality of charging conductors 31 may be disposed to be spaced apart from each other along a circle path of the insulating body 32 by the insulating body 32. That is, the plurality of charging conductors 31 may be spaced apart from each other in the circumferential direction of the insulating body 32.

The insulating body 32 may be an electrically insulator, and the insulating body 32 may be a charging outer shell capable of insulating at least one charging conductor 31. The insulating body 32 may be a heat transfer member capable of transferring heat of the charging conductor 31 to a cooling fluid C, see FIG. 4.

The insulating body 32 may surround an outer circumference 31a, see FIG. 4 of at least one charging conductor 31. An inner flow path IF through which cooling fluid C passes may be formed in the insulating body 32. The inner flow path IF may be formed on the inside of the insulating body 32 and may be formed long in the longitudinal direction of the insulating body 32. The cross-sectional area of the inner flow path IF may be smaller than the cross-sectional area of the outer flow path OF described later.

The insulating body 32 may be a charging outer shell having an inner flow path IF formed inside. The insulating body 32 may be formed in a hollow shape, and the insulating body 32 may comprise an outer circumference 32a and an inner circumference 32b.

The outer circumference 32a of the insulating body 32 may be spaced apart from the inner circumference of the outer tube 2.

The inner circumference 32b of the insulating body 32 may form an inner flow path IF.

The inner flow path IF may be formed inside the inner circumference 32b of the insulating body 32. The inner flow path IP may be formed long in the length direction of the insulating body 32 inside the insulating body 32.

The insulating body 32 may comprise an insulating portion 33 and a bridge portion 34, as shown in FIGS. 4 and 5.

The insulating portion 33 may surround the outer circumference 31a of the charging conductor 31. The cross section of the insulating portion 33 may be ring-shaped. The insulating body 32 may comprise a plurality of insulating portions 33.

A charging conductor 31 may be accommodated inside one insulating portion 33.

The plurality of insulating portions 33 may be formed in a row along a circular trajectory. The plurality of insulating portions 33 may be spaced apart from each other. A plurality of insulating portions 33 may be spaced apart from each other in the circumferential direction of the insulating body 32.

A bridge portion 34 may connect a pair of adjacent insulating portions 33 among the plurality of insulating portions 33. The insulating portion 33 and the bridge portion 34 may be alternately formed in the circumferential direction of the insulating body 32.

The insulating body 32 may have mountains and valleys alternately formed in the circumferential direction. The outer circumference 32a of the insulating body 32 may have mountains and valleys alternately formed in the circumferential direction. The inner circumference 32b of the insulating body 32 may have mountains and valleys alternately formed in the circumferential direction.

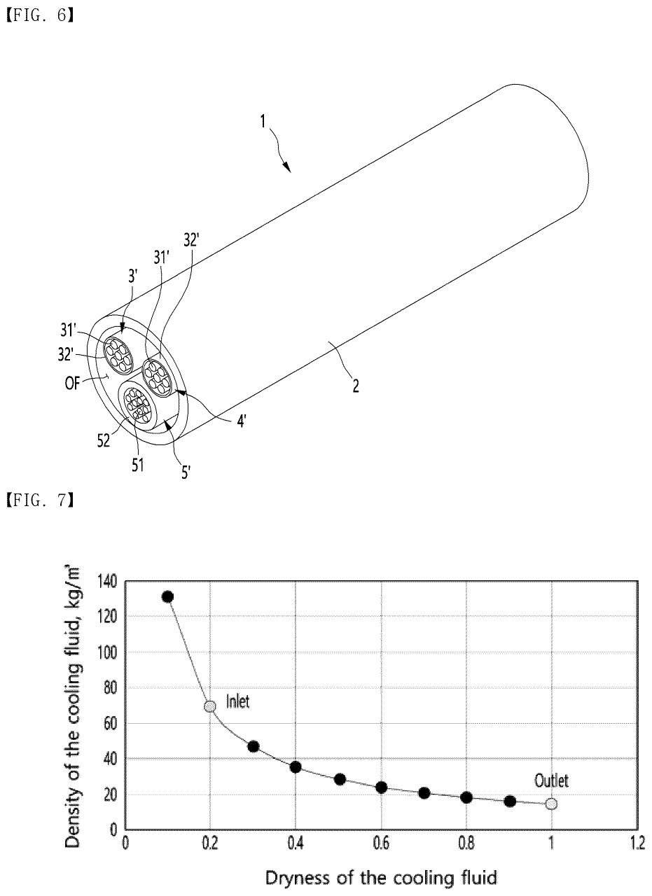

A cooling fluid recovery hole 35, see FIGS. 5 and 6 through which a cooling fluid C passes may be formed in the bridge portion 34. The cooling fluid recovery hole 55 may be formed long in the longitudinal direction of the insulating body 32. The cooling fluid recovery hole 55 may be formed by a long slit in the longitudinal direction of the insulating body 32.

The cooling fluid recovery hole 35 may be close to the opposite sides of the cooling fluid supply unit 8 and the cooling fluid recovery unit 9. The cooling fluid supply unit 8 and the cooling fluid recovery unit 9 may be close to one of the one end and the other end of the inner flow path IF, and the cooling fluid recovery hole 35 may be close to the other end of the one end and the other end of the inner flow path IF.

The insulating body 32 may comprise a blocking plate 39, see FIG. 3 that blocks the other end of the inner flow path IF. The cooling fluid C may be guided to the cooling fluid recovery hole 35 by the blocking plate 39.

The charging cable 1 may be formed with an outer flow path OF through which the cooling fluid C passes.

The outer flow path OF may be formed between at least one charging line 34 and the outer tube 2. The outer flow path OF may be formed between the outer circumference 32a of at least one charging line 34 and the inner circumference of the outer tube 2.

If the charging cable 1 further comprises a communication line 5, the outer flow path OF may be formed between the outer tube 2 and at least one charging line 34 and the communication line 5. The outer flow path OF may be formed between the outer circumference 32a of at least one charging line 34, the outer circumference 52a of the communication line 5, and the inner circumference of the outer tube 2.

The outer flow path OF may be parallel to the inner flow path IF. The outer flow path OF may surround the outer circumference of the insulating body 32. The outer flow path OF may be separated from the inner flow path IF with the insulating body 32.

The cooling fluid C may absorb heat transferred radially inwardly of the insulating body 32 while passing through the inner flow path IF.

The cooling fluid C may flow to the outer flow path OF through the cooling fluid recovery hole 55 after passing through the inner flow path IF.

The cooling fluid C flowing to the outer flow path OF may absorb heat transferred radially outwardly of the insulating body 32 while passing through the outer flow path OF.

That is, the cooling fluid C flowing through the charging cable 1 may primarily absorb the heat of the charging conductor 31 while passing through the inner side of the insulating body 32, and secondarily absorb the heat of the charging conductor 31 while passing through the outer side of the insulating body 32 through the cooling fluid recovery hole 35.

The communication line 5 may be disposed inside the outer tube 2.

The communication line 5 may comprise a communication conductor 51 and a communication outer shell 52 surrounding the outer circumference 51a of the communication conductor 51.

A plurality of communication conductors 51 may be disposed on the inner side of the communication outer shell 52.

The outer circumference 52a of the communication outer shell 52 may have a smooth surface.

A connection terminal 6, see FIG. 1 may be provided at one end of the charging cable 1. A charger capable of charging an electric vehicle may comprise a power supply, and a connection terminal 6 formed at one end of a charging cable 1 may be connected to the power supply provided in the charger.

A plurality of connection terminals 6 may be provided at one end of the charging cable 1. A pair of connection terminals 6 may be provided, and one of the connection terminals 6 of the pair of connection terminals 6 may be connected to one charging line 3, and the other of the connection terminals 6 of the pair of connection terminals 6 may be connected to the other charging line 4.

A connector 7, see FIG. 1 may be provided at the other end of the charging cable 1. The connector 7 may have a shape corresponding to a charging port of the electric vehicle, and may comprise a charging terminal and a communication terminal connected to the electric vehicle.

The charging cable 1 may further comprise a cooling fluid supply unit 8, see FIG. 1 and a cooling fluid recovery unit 9, see FIG. 1.

The cooling fluid supply unit 8 may supply cooling fluid C to the inner flow path IF. The cooling fluid supply unit 8 may be formed with a supply flow path that is connected to the inner flow path IF. Examples of the cooling fluid supply unit 8 may be a supply tube or a cooling fluid supply body having a supply flow path formed inside. The cooling fluid supply unit 8 may be connected to one side of the charging line 3.

The cooling fluid recovery unit 9 may guide the cooling fluid C that has passed through the outer flow path OF. The cooling fluid recovery unit 9 may be formed with a recovery flow path that is connected to the outer flow path OF. Examples of the cooling fluid recovery unit 9 may be a recovery tube or a cooling fluid recovery body having a recovery flow path formed inside. The cooling fluid recovery unit 9 may be connected to one side of the outer tube 2.

The charging cable 1 may be a direct expansion heat exchanger or a direct expansion evaporator, and the cooler may comprise a compressor connected to the charging cable 1, a condenser connected to the compressor, and an expansion mechanism such as an expansion valve connected to the condenser and the charging cable.

The cooling fluid supply unit 8 is connected to the expansion mechanism and may guide the cooling fluid passed through the expansion mechanism to the inner flow path IF. A two-phase cooling fluid may flow in the cooling fluid supply unit 8, and this two-phase cooling fluid may absorb heat from the charging conductor 31 while passing through the inner flow path IF.

The cooling fluid recovery unit 9 is connected to the compressor and may guide the cooling fluid passed through the outer flow path OF to the compressor. The cooling fluid passing through the outer flow path OF may vaporize while absorbing heat from the charging conductor 31, and the vaporized cooling fluid may flow to the cooling fluid absorption unit 9.

In this embodiment, the density change of the cooling fluid C due to heat transfer of the cooling fluid C may be large, and the cross-sectional area of the inner flow path IF may be different from that of the outer flow path OF. It is preferable that the cross-sectional area of the inner flow path IF is smaller than the cross-sectional area of the outer flow path OF.

FIG. 6 is a partially cut away perspective view of a comparative example compared to an example of a charging cable according to the present embodiment.

The charging cable of the comparative example may comprise an outer tube 2, a charging line 3′ 4′, and a communication line 5. The configuration of the outer tube 2 and the communication line 5 may be the same as that of the example of the charging cable of the present embodiment.

The charging line 3′ 4′ may have a plurality of charging conductors 31′ disposed inside a hollow insulating body 32′. The plurality of charging conductors 31′ may be filled in a space formed inside the insulating body 32′. An inner path through which a cooling fluid passes may not be formed inside the charging line 3′ 4′.

In the charging cable of the comparative example, an outer flow path OF may be formed between the outer circumference of the charging line 3′4′, the outer circumference of the communication line 5, and the inner circumference of the outer tube 2, and the cooling fluid may flow into the outer flow path OF, pass through the outer flow path OF, and flow outward from the outer flow path OF.

In the comparative example, one end of the outer flow path OF may be the inlet of the cooling fluid, the other end of the outer flow path OF may be the outlet of the cooling fluid, and the cross-sectional areas of the inlet and the outlet may be the same.

In the comparative example, the flow and heat transfer of the cooling fluid may occur only through the outer flow path OF in the charging cable, and the heat transfer area of the cooling fluid C may be smaller than in the present embodiment.

The comparative example has a disadvantage in that the charging conductor 31′ relatively close to the insulating body 32′ among the plurality of charging conductors 31′ is cooled primarily, and not all charging conductors 31′ of the charging cables 3′ 4′ are cooled quickly.

On the other hand, the charging cable 1 of the present embodiment may cool all charging conductors 31 evenly and quickly by the inner flow path IF.

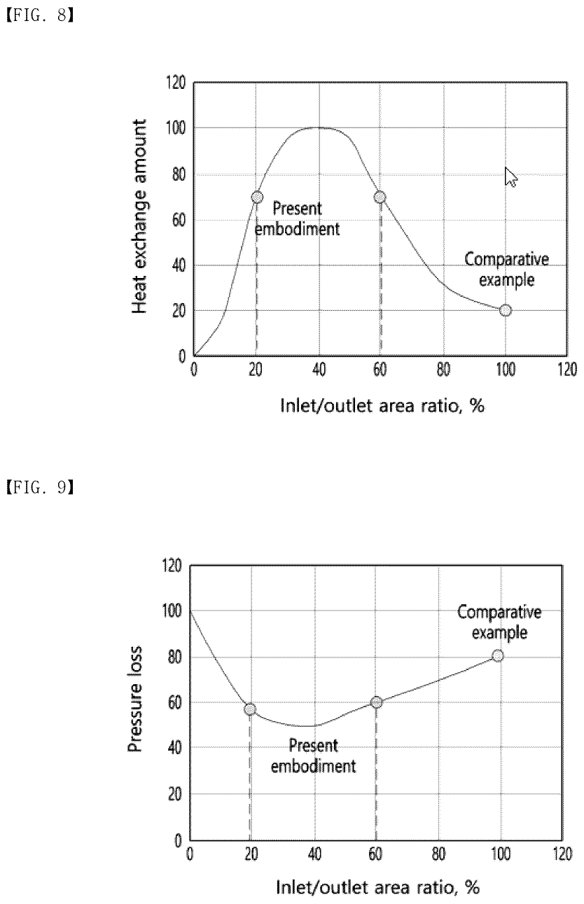

FIG. 7 is a diagram showing the dryness and density of the cooling fluid according to the present embodiment, FIG. 8 is a graph showing the heat exchange amount of an example of a charging cable according to the present embodiment and the heat exchange amount of a comparative example, and FIG. 9 is a graph showing the cooling fluid pressure loss of an example of a charging cable according to the present embodiment and the cooling fluid pressure loss of a comparative example.

The cooling fluid C of the charging cable 1 according to this embodiment is a refrigerant that may change phase (liquefy or vaporize) according to temperature change, and may be, for example, one of R134a, freon, hydrocarbon, ammonia, and carbon dioxide-based refrigerant.

Hereinafter, the cooling fluid C is described as R134a, but the cooling fluid of this embodiment is not limited to R134a, and any cooling fluid that may change phase (liquefy or vaporize) according to temperature change may be applied.

Hereinafter, the inner flow path IF is described as an inlet IF, and the outer flow path OF is described as an outlet IF.

As shown in FIG. 7, R134 may have different densities at the inlet IF and the outlet OF, and the density at the inlet IF may be 69.063 kg/m3 and the density at the outlet OF may be 14.428 kg/m 3 , and the density at the inlet IF and the density at the outlet OF may differ by approximately 4.8 times.

Considering the density difference of the cooling fluid C as described above, it is preferable that the cross-sectional area of the inlet IF hereinafter referred to as the area of the inlet IF be smaller than the cross-sectional area of the outlet OF hereinafter referred to as the area of the outlet OF.

FIG. 8 is an example showing the heat exchange amount according to the inlet/outlet area ratio, and FIG. 9 is an example showing the pressure loss on the cooling fluid according to the inlet/outlet area ratio.

The inlet/outlet area ratio is the ratio of the sum of the areas of the inner flow paths IF of each of a pair of charging lines 34 and the area of the outer flow path OF. If the area of the inner flow path IF of one 3 of a pair of charging lines 34 is A1, the area of the inner flow path IF of the other 4 of a pair of charging lines 34 is A2, and the area of the outer flow path OF is A3, the inlet/outlet area ratio may be A1+A2/A3.

Referring to FIGS. 8 and 9, it is preferable that the inlet/outlet area ratio A1+A2/A3 is 20% to 60%, and when the sum of the areas of a pair of inner flow paths IF is 0.2 to 0.6 times the area of one outer flow path OF, the heat exchange amount of the cooling fluid may be increased, and the pressure loss on the cooling fluid may be reduced.

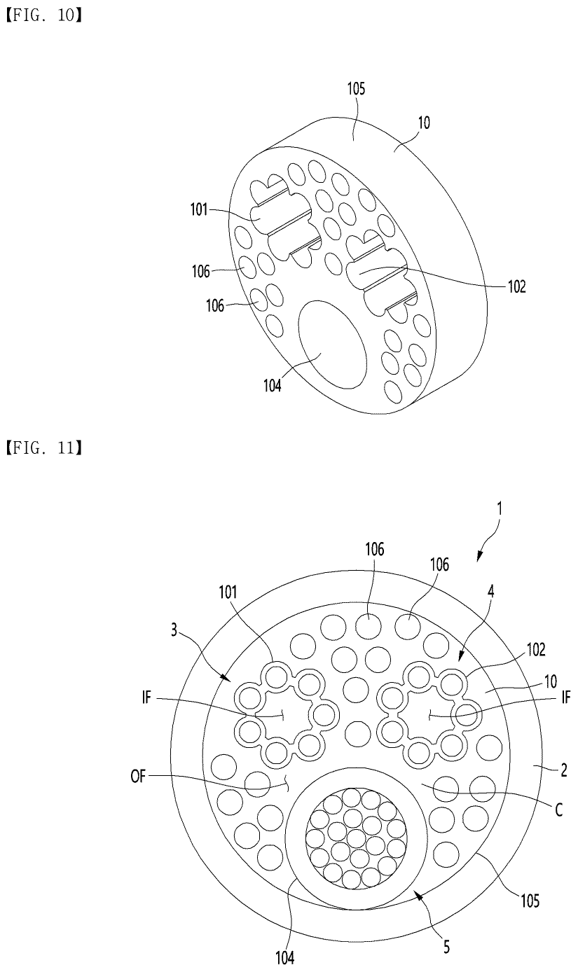

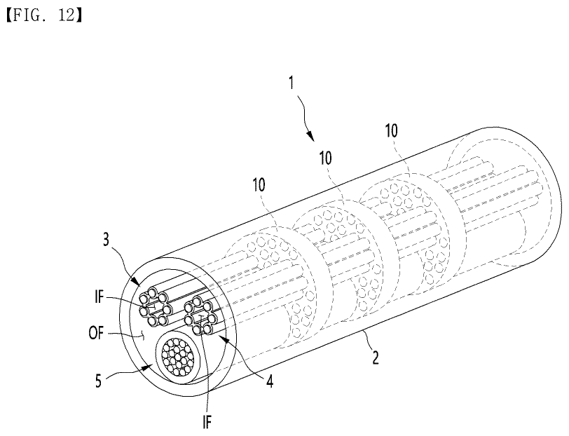

FIG. 10 is a perspective view of a supporter according to the present embodiment, FIG. 11 is a cross-sectional view illustrating an example of a supporter according to the present embodiment being installed inside an outer tube, and FIG. 12 is a perspective view illustrating an example of a supporter according to the present embodiment being installed inside an outer tube.

The charging cable may comprise a supporter 10.

The supporter 10 may be disposed inside the outer tube 2. The supporter 10 may support a pair of charging lines 34 and a communication line 5 respectively.

The supporter 10 may support a pair of charging lines 34 and a communication line 5 so that the charging lines 34 and the communication line 5 are spaced apart from each other. The pair of charging lines 34 and the communication line 5 may be supported by the supporter 10 so that the pair of charging lines 34 and the communication line 5 are spaced apart from the outer tube 2.

The supporter 10 may support the charging lines 34 and the communication line 5 so that the outer circumference of the charging lines 34 and the outer circumference of the communication line 5 are spaced apart from the inner circumference of the outer tube 2.

The supporter 10 may comprise a charging line penetration hole 101 and 102 through which the charging line 34 passes, and a communication line penetration hole 104 through which the communication line 5 passes.

The charging line penetration hole 101 and 102 may have a shape in which mountains and valleys are alternately formed, like the charging line 34. The charging line 34 may be supported by the periphery of the charging line penetration hole 101102.

The communication line penetration hole 104 may be circular, like the communication line 5. The communication line 5 may be supported by the periphery of the communication line penetration hole 104.

The outer circumference 105 of the supporter 10 may be circular, and the outer circumference 104 of the supporter 10 may be in contact with the inner circumference of the outer tube 2.

A plurality of through holes 106 may be formed in the supporter 10. Each of the plurality of through holes 105 may be spaced apart from each of the charging line through holes 101 and 102 and the communication line through holes 104.

The plurality of through holes 106 may be formed between the charging line through holes 101 and 102 and the outer circumference 105 of the supporter 10. The plurality of through holes 106 may be formed between the communication line through holes 104 and the outer circumference 106 of the supporter 10. The plurality of through holes 106 may be formed between the charging line through holes 101 and 102 and the communication line through holes 104.

When the cooling fluid C passes through the inside of the outer tube 2, the cooling fluid may be minimized from being concentrated to one side by the supporter 10, and the charging cable 1 may cool the charging line 3 and 4 and the communication line 5 as evenly as possible.

The above description is merely an illustrative explanation of the technical idea of the present disclosure, and various modifications and variations will be possible to those skilled in the art without departing from the essential characteristics of the present disclosure.

Accordingly, the embodiments disclosed in the present disclosure are not intended to limit the technical idea of the present disclosure, but rather to explain it, and the scope of the technical idea of the present disclosure is not limited by these embodiments.

The scope of protection of the present disclosure should be interpreted in accordance with the claims below, and all technical ideas within the equivalent scope should be construed as being comprised in the scope of rights of the present disclosure.

1.-11. (canceled)

12. A charging cable comprising:
an outer tube;
a communication line arranged inside the outer tube; and
at least one charging line disposed inside the outer tube and having an inner flow path formed through which cooling fluid passes,
wherein an outer flow path through which cooling fluid passes is formed between the outer tube, the communication line, and the at least one charging line,
wherein a cross-sectional area of the inner flow path is smaller than a cross-sectional area of the outer flow path,
wherein the charging line comprises:
at least one charging conductor; and
an insulating body surrounding an outer circumference of the at least one charging conductor,
wherein the inner flow path is formed on an inner circumference of the insulating body and is long in a longitudinal direction of the insulating body,
wherein the insulating body comprises:
a plurality of insulating portions surrounding an outer circumference of the charging conductor; and
a bridge portion connecting adjacent insulating portions among the plurality of insulating portions, and
wherein at least one cooling fluid recovery hole through which the cooling fluid of the inner flow path flows to the outer flow path is formed on the bridge portion.

13. The charging cable of claim 12, further comprising:
a cooling fluid supply unit configured to supply cooling fluid to the inner flow path; and
a cooling fluid recovery unit through which the cooling fluid passing through the outer flow path is guided.

14. The charging cable of claim 12, wherein the cross-sectional area of the inner flow path is 0.2 to 0.6 times the cross-sectional area of the outer flow path.

15. The charging cable of claim 12, further comprising a supporter disposed inside the outer tube and formed with a charging line penetration hole through which the charging line passes and a communication line penetration hole through which the communication line passes.

16. The charging cable of claim 15, wherein a plurality of through holes is formed in the supporter.

17. The charging cable of claim 15, wherein the supporter is disposed in plurality inside the outer tube, and
wherein the plurality of supporters is spaced apart in a longitudinal direction of the outer tube.

18. A charging cable comprising:
an outer tube;
a communication line disposed inside the outer tube;
at least one charging line disposed inside the outer tube and having an inner flow path formed through which a cooling fluid passes;
a cooling fluid supply body supplying cooling fluid to the inner flow path; and
a cooling fluid recovery body guiding the cooling fluid passing through the outer flow path,
wherein an outer flow path through which the cooling fluid passes is formed between the outer tube, the communication line, and at least one charging line,
wherein a cross-sectional area of the inner flow path is 0.2 to 0.6 times a cross-sectional area of the outer flow path,
wherein the charging line comprises:
at least one charging conductor; and
an insulating body surrounding an outer circumference of the at least one charging conductor,
wherein the inner flow path is formed on an inner circumference of the insulating body and is long in a longitudinal direction of the insulating body,
wherein the insulating body comprises:
a plurality of insulating portions surrounding an outer circumference of the charging conductor; and
a bridge portion connecting adjacent insulating portions among the plurality of insulating portions, and
wherein at least one cooling fluid recovery hole through which the cooling fluid of the inner flow path flows to the outer flow path is formed on the bridge portion.

19. A charging cable comprising:
an outer tube;
a communication line and at least one charging line disposed inside the outer tube; and
a supporter disposed inside the outer tube and having a charging line through-hole through which the charging line passes and a communication line through-hole through which the communication line passes are formed,
wherein a plurality of through-holes for dispersing a cooling fluid are formed on the supporter,
wherein the charging line comprises:
at least one charging conductor; and
an insulating body surrounding an outer circumference of the at least one charging conductor,
wherein the inner flow path is formed on an inner circumference of the insulating body and is long in a longitudinal direction of the insulating body,
wherein the insulating body comprises:
a plurality of insulating portions surrounding an outer circumference of the charging conductor, and
a bridge portion connecting adjacent insulating portions among the plurality of insulating portions, and
wherein at least one cooling fluid recovery hole through which the cooling fluid of the inner flow path flows to the outer flow path is formed on the bridge portion.

20. The charging cable of claim 19, wherein the insulating body has mountains and valleys alternately formed in a circumferential direction.

21. The charging cable of claim 19, wherein the charging line through-hole has a shape in which mountains and valleys are alternately formed.

22. The charging cable of claim 19, wherein the communication line through-hole is circular.

23. The charging cable of claim 19, wherein an outer circumference of the supporter is circular.
